(19) United States
(12) Patent Application Publication
(10) Pub. No.: US 2026/0149761 A1
(43) Pub. Date: May 28, 2026

(54) TCP PORT RESERVATION CONSISTENT WITH OPERATING SYSTEM NAMESPACES

(71) Applicant: SAP SE, Walldorf (DE)

(72) Inventors: Oliver Schmidt, Woerth (DE); Steffen Lammel, St. Leon-Rot (DE); Andreas Ludwig Erz, Mannheim (DE)

(21) Appl. No.: 18/956,477

(22) Filed: Nov. 22, 2024

(51) Int. Cl. H04L 69/163; H04L 67/141

(52) U.S. Cl. CPC H04L 69/163; H04L 67/141

(57) ABSTRACT

Programs run in different file module specific namespaces do not share the same file system. For every port number, there is both a TCP port and a UDP port. However, UDP ports are more rarely used. Additionally, UDP ports and TCP ports are in the same (network module specific) namespace. Accordingly, a test script attempts to reserve a UDP port with a particular port number. If the reservation is successful, the test script creates an instance of a program that will use the corresponding TCP port. If the reservation fails, another test script has already reserved that port and this test script tries a different port number. As a result of using the UDP port-based reservation scheme, test execution scripts are enabled to coordinate the reservation of TCP ports, consistent with operating system namespaces.

### TECHNICAL FIELD

The subject matter disclosed herein generally relates to reservation of Transmission Control Protocol (TCP) ports and, more specifically, to TCP port reservation that is consistent with operating system namespaces.

### BACKGROUND

For external systems to initiate communications with an application using TCP, the TCP port used by the application must be known to the external system and reserved to the application. As an example, web servers listen on TCP port 80 for hypertext transport protocol (HTTP) communications and on TCP port 443 for HTTP secure (HTTPS) communications.

During testing of an application, multiple instances of the application may be run on a single system. Since only one process can bind to each TCP port, the different instances must use different TCP ports, most of which will not be the standard port that will be used by the application during deployment.

Namespaces are an operating-system feature that partition resources such that different sets of processes access different sets of resources. A file module specific namespace controls access to a file system. Processes executing in the same file module specific namespace that use the same path and filename access the same file. Processes executing in different file module specific namespaces cannot access the same files. A network module specific namespace has a private set of Internet protocol (IP) address, routing tables, sockets, and so on. Processes executing in the same network module specific namespace share network resources. Processes executing in different network module specific namespaces have independent sets of network resources.

When the instances are all running within a single file module specific namespace, lock files may be used. For example, a TCP port may be reserved by creating, in a particular directory, a file called <port>. lock, where <port> is replaced with the number for the TCP port being reserved. If the file creation fails, this shows that the port was already reserved and a different port number is tried. If the file creation succeeds, the instance uses the newly reserved TCP port.

### BRIEF DESCRIPTION OF THE DRAWINGS

FIG. 1 shows a network diagram illustrating an example network environment suitable for providing TCP port reservations that are consistent with operating system namespaces.

FIG. 2 shows a block diagram of components of an application server suitable for providing TCP port reservations that are consistent with operating system namespaces, according to some example embodiments.

FIG. 3 is a block diagram of a file system suitable for use in a file-based TCP port reservation system.

FIG. 4 is a block diagram of a file system illustrating a failure of a file-based TCP port reservation system when instances execute in different file module specific namespaces.

FIG. 5 is a block diagram of UDP and TCP ports, suitable for providing TCP port reservations that are consistent with operating system namespaces, according to some example embodiments.

FIG. 6 shows a flowchart illustrating a method of providing TCP port reservations that are consistent with operating system namespaces.

FIG. 7 shows a flowchart illustrating a method of providing TCP port reservations that are consistent with operating system namespaces and using the reserved TCP ports for application testing.

FIG. 8 illustrates four combinations of operating system namespaces for two test scripts.

FIG. 9 shows a block diagram showing one example of a software architecture for a computing device.

FIG. 10 shows a block diagram of a machine in the example form of a computer system within which instructions may be executed for causing the machine to perform any one or more of the methodologies discussed herein.

### DETAILED DESCRIPTION

Example methods and systems are directed to providing TCP port reservations that are consistent with operating system namespaces. Usually, a server program binds to a TCP port with a well-known number provided to it in order to be discoverable by client programs. However, when testing a server program, testing may be more performed more efficiently by running many instances of that server program at once in order to parallelize the test execution. In this scenario, each server program instance requires a different TCP port number, since only one program can bind to a TCP port with a certain number. Those different TCP port numbers are then given to the many client program instances which connect to the server program instances in order to perform specific tests.

Since, during deployment, server programs expect to run using a TCP port with a well-known number, the server program being tested may not have good error-handling for a TCP port binding failure. Accordingly, the reservation of a TCP port for each instance of the server program being tested may be more safely performed by a test execution script. This allows for the server program to be tested without forcing development of TCP port error handling to be unduly prioritized.

Communication between instances of the test execution script to ensure that the same TCP port is not used twice is traditionally done by trying to create files. The content of the files isn't relevant, rather only the name of the files is relevant. For example, the files might be named ‘<portnumber>.lock’, e.g. ‘8086.lock’. If a test execution script succeeds in newly creating the file, then the corresponding TCP port number (e.g., 8086) was free and is now, by virtue of the lock file existing, marked as used. This script now owns the TCP port number and can safely execute a server program instance that uses TCP port 8086. Another test execution script that attempts to create the same file with receive a failure code from the operating system and try to reserve a different TCP port before creating a new instance of the server program.

This traditional approach has worked fine for quite some time. However, more recent operating environments make ever increasing use of virtualization and containerization. In those environments the TCP ports and the files are not necessarily shared in the same way. For example, programs may be run in different file module specific namespaces but in the same network module specific namespace. As a result, they do not share the same file system, but do share the same TCP ports.

Two test execution scripts executing in different file module specific namespaces cannot use files to coordinate. Both scripts can successfully create files with identical paths and names, and thus may determine to use the same TCP port. Each script starts a test instance of the server program, instructed to use the same TCP port. However, when the second test instance is created, it will fail to bind the TCP port, since the first test instance has already bound to that port.

As disclosed herein, instead of relying on files to mark a used TCP port number, UDP ports are used. For every port number, there is both a TCP port and a UDP port. However, UDP ports are more rarely used. Additionally, UDP ports and TCP ports are in the same network module specific namespace. Accordingly, the test script attempts to reserve a UDP port with a particular port number (e.g., 8086). If the reservation is successful, the test script creates an instance of the server program that will use the corresponding TCP port. If the reservation fails, another test script has already reserved that port and this test script tries a different port number.

As a result of using the UDP port-based reservation scheme, test execution scripts are enabled to coordinate the reservation of TCP ports, even if they do not have access to a shared file system. Accordingly, test servers are enabled to execute multiple instances of a server program being tested, improving the efficiency of software development testing.

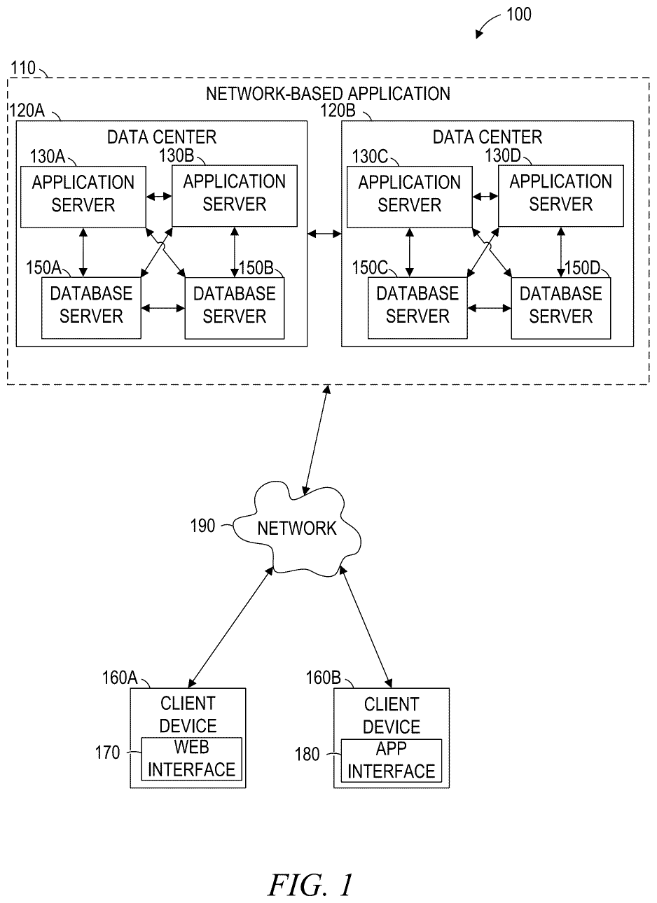

FIG. 1 shows a network diagram illustrating an example network environment 100 suitable for providing TCP port reservations that are consistent with operating system namespaces. The network environment 100 includes a network-based application 110, client devices 160A and 160B, and a network 190. The network-based application 110 is integrated across two data centers 120A and 120B. The data center 120A comprises application servers 130A and 130B in communication with database servers 150A and 150B. The data center 120B comprises application servers 130C and 130D in communication with database servers 150C and 150D. An application executing on the application servers 130A-130B may access data from the database servers 150A-150B. Similarly, an application executing on the application servers 130C-130D may access data from the database servers 150C-150D. The letter suffixes of reference numbers may be omitted when doing so does not raise ambiguity. For example, the application servers 130A-130D may be referred to collectively as “application servers 130.” Similarly, when the specific one of the application servers 130A-130D is not of particular import, “application server 130” may be referenced.

The data center 120A may provide a production version of the network-based application that is used by end-users. The data center 120B may be used for testing development versions of the network-based application before deploying them to production. In the production environment, each application server 130A-130B may run at most one instance of the application, and each instance of the application may use a fixed TCP port. In the testing environment, each application server 130C-130D may run multiple instances of the application, and each instance of the application may use a TCP port that is assigned to the instance by a launch script. For example, the command-line for the instance may identify the TCP port to use. For either the production environment or the testing environment, the user interface for the application may be presented using a web interface 170 or an app interface 180.

The application servers 130 may communicate with the database servers 150 using a representational state transfer (REST) API, the Open Data Protocol (ODATA), or another API. The data may be described in metadata that provides contextual information related to the data. Metadata includes column names, data types and data relationships. If the values are from a fixed dataset, the dataset may be loaded and the loaded information used as a table description.

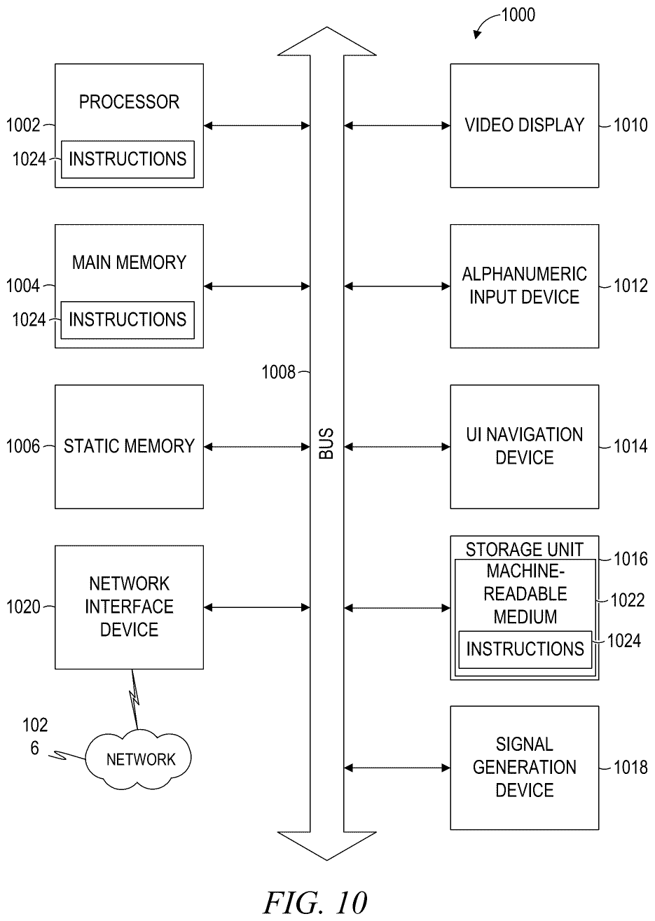

The application servers 130A-130D, the database servers 150A-150D, and the client devices 160A-160B may each be implemented in a computer system, in whole or in part, as described below with respect to FIG. 10. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130D, the database servers 150A-150D, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or a few of each element (e.g., four application servers 130A-130D, two client devices 160A and 160B, and the like), any number of each element is contemplated. For example, the application server 130A may be one of dozens or hundreds of active and standby servers and provide services to millions of client devices.

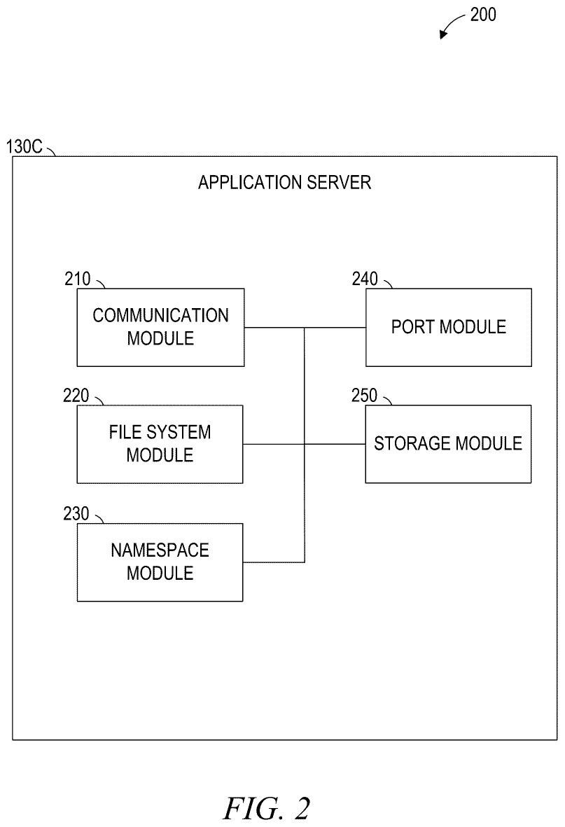

FIG. 2 shows a block diagram of components of the application server 130C suitable for providing TCP port reservations that are consistent with operating system namespaces, according to some example embodiments. The application server 130C is shown as including a communication module 210, a file system module 220, a namespace module 230, a port module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130C and transmits data from the application server 130C. For example, the communication module 210 may receive an instruction to start an instance of an application and, in response, start a test script that determines a TCP port to be used by the instance and starts the instance.

The file system module 220 accesses a file system. For example, a script running on the application server 130A may attempt to create a lock file using the file system module 220. If the creation of the file is successful, the script has exclusive use of a corresponding resource. When the script no longer needs the resource, the script deletes the lock file. If the creation of the file fails, the script knows that another process is using the resource. However, the file system module 220 can access files only in the file module specific namespace of the process. Accordingly, a process that is executing in a different file module specific namespace will not share the same lock file, rendering lock files ineffective for resource allocation.

The namespace module 230 assigns namespaces to processes. For example, the application server 130C may be configured to use two file module specific namespaces. Two or more virtual machines may run on the application server 130C, each virtual machine assigned one of the two file module specific namespaces. The virtual machines that run in different file module specific namespaces do not share a file system, and thus the file system module 220 will not be able to access the same files for the virtual machines. The virtual machines that run in the same file module specific namespace share a file system, and thus the file system module 220 will be able to access the same files for the virtual machines.

Allocation of resources may be performed by the port module 240 instead of the file system module 220. The port module 240 binds to UDP ports, TCP ports, or both. A script running on the application server 130A may attempt to bind to a UDP port with a port number. If the port binding is successful, the script has exclusive use of the corresponding TCP port with the same port number. When the script no longer needs the TCP port, the UDP port is released. If the UDP port binding fails, the script knows that another process is using the TCP port. Since UDP ports are shared in the same namespace as TCP ports, the use of UDP ports for coordination between scripts will be effective regardless of whether the scripts are running in the same or different file module specific namespace, the same or different network module specific namespace, or any suitable combination thereof.

Data, metadata, documents, instructions, or any suitable combination thereof may be stored and accessed by the storage module 250. For example, local storage of the application server 130A, such as a hard drive, may be used. As another example, network storage may be accessed by the storage module 250 via the network 190.

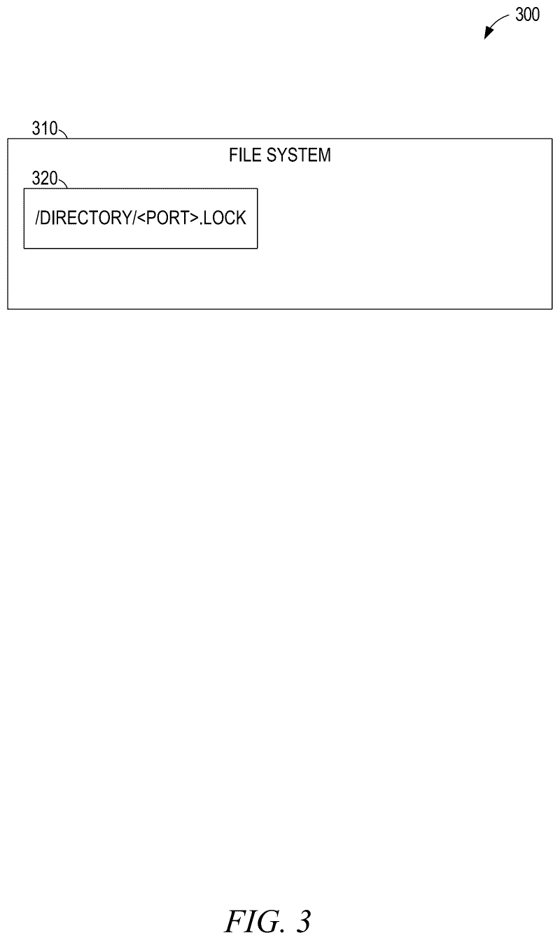

FIG. 3 is a block diagram 300 of a file system 310 suitable for use in a file-based TCP port reservation system. A lock file 320 is created by a process to indicate that a corresponding resource is reserved for exclusive use by the process. The lock file may use the extension, “.lock,” have a name that identifies the reserved resource, and be located in a predetermined directory. For example, the file “/directory/1999.lock” may be used to indicate that TCP port 1999 is reserved for use by the process that created the file. If two processes attempt to create the file at essentially the same time, the operating system resolves the race condition, causing one process to successfully create the file and the other process's attempt to fail.

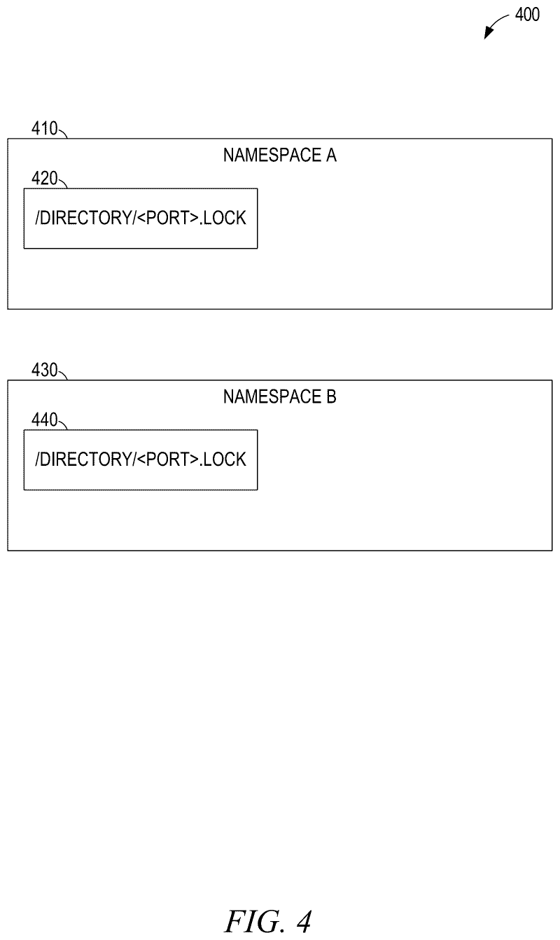

FIG. 4 is a block diagram 400 of a file system illustrating a failure of a file-based TCP port reservation system when instances execute in different file module specific namespaces, file module specific namespace A 410 and file module specific namespace B 430. A first script executing in file module specific namespace A 410 attempts to create a lock file 420 to reserve a corresponding TCP port. For example, the first script may attempt to create the file “/directory/1999.lock.” Upon succeeding, the first script determines that the TCP port numbered 1999 is reserved for its use. A second script, executing in file module specific namespace B 430, also attempts to create a lock file 440 to reserve a corresponding TCP port. The second script may also attempt to create the file “/directory/1999.lock.” Since the second script is executing in a different file module specific namespace from the one in which the file was already created, this file creation attempt also succeeds. Accordingly, the second script also determines that the TCP port numbered 1999 is reserved for its use. As a result, both scripts begin instances of the application under test, directing the instances to use the same TCP port, and the file-based TCP port reservation system has failed in its purpose.

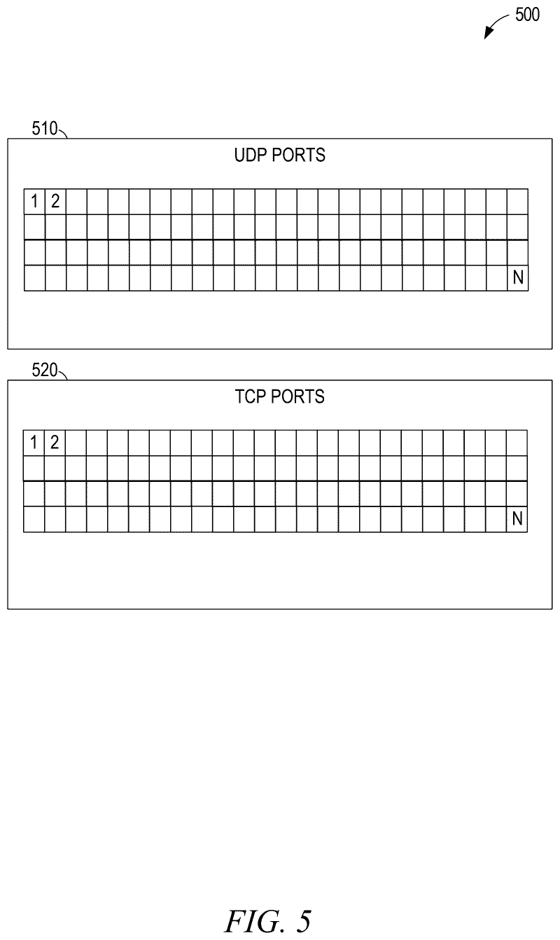

FIG. 5 is a block diagram of UDP ports 510 and TCP ports 520, suitable for providing TCP port reservations that are consistent with operating system namespaces, according to some example embodiments. In a computer system, UDP ports 510 and TCP ports 520 are numbered in a range of 1-N (e.g., from 1-65536). For each one of the UDP ports 510, a corresponding one of the TCP ports 520 exists, using the same port number.

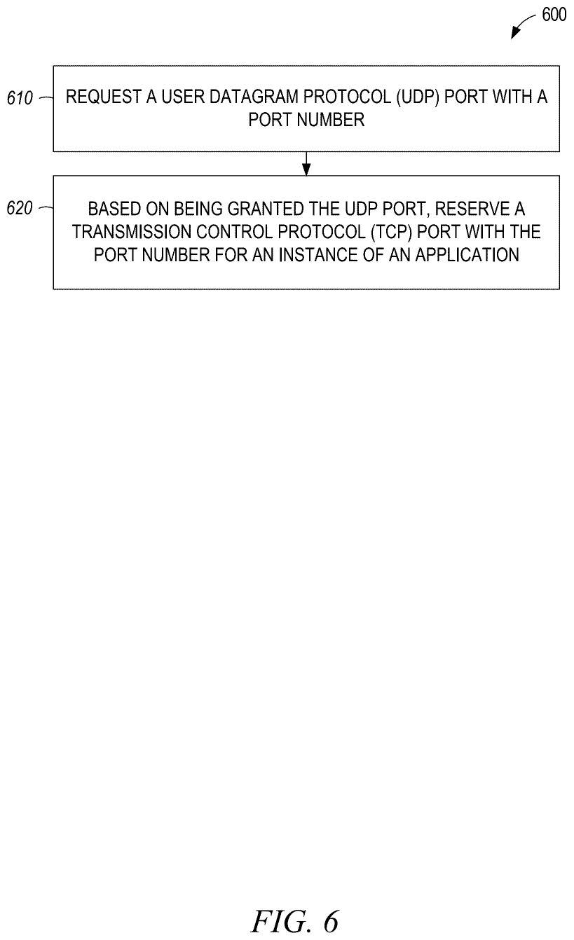

FIG. 6 shows a flowchart illustrating a method 600 of providing TCP port reservations that are consistent with operating system namespaces. The method 600 includes operations 610 and 620. By way of example and not limitation, the method 600 is described as being performed by the application server 130C of FIG. 1, using the modules of FIG. 2, and the ports of FIG. 5.

In operation 610, a test script requests a UDP port with a port number. For example, the test script may attempt to bind to UDP port 1999. If the attempt fails, operation 610 may be repeated with a different port number (e.g., by incrementing the port number). This process may be repeated until a request is granted or requests have been made for all port numbers.

Based on being granted the UDP port, the test script reserves a TCP port with the port number for an instance of an application (operation 620). For example, if the attempt to bind to UDP port 1999 was successful, the test script may use a command-line instruction to start the instance of the application, passing a command-line argument that indicates that TCP port 1999 is to be used by the application. As a result, the instance of the application uses the reserved TCP port. When the instance terminates, the TCP port is released. When the test script terminates or detects that the instance has terminated, the UDP port is released. As a result, a future test script can bind to the same UDP port and the corresponding TCP port may be reused. However, during the period of time that the instance is using the TCP port, no other test script will successfully request the corresponding UDP port, and so no other instance will be created that attempts to use the same TCP port.

Since ports in a network module specific namespace are shared without regard to file module specific namespaces, the TCP port reservation process of the method 600 will be effective even when the test scripts are executing in different file module specific namespaces. Thus, the method 600 improves over existing, file-based, methods of assigning ports, which fail when the test scripts are executing in different file module specific namespaces, as shown in FIG. 5.

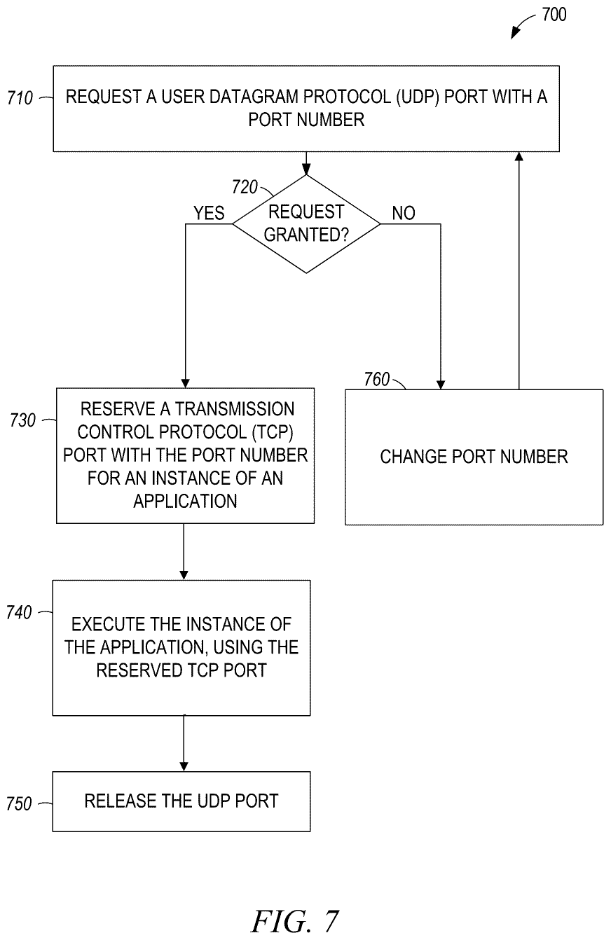

FIG. 7 shows a flowchart illustrating a method 700 of providing TCP port reservations that are consistent with operating system namespaces and using the reserved TCP ports for application testing. The method 700 includes operations 710, 720, 730, 740, 750, and 760. By way of example and not limitation, the method 700 is described as being performed by the application server 130C of FIG. 1, using the modules of FIG. 2, and the ports of FIG. 5.

In operation 710, a test script requests a UDP port with a port number. For example, the test script may attempt to bind to UDP port 1999. The port number may be selected from an allowed list of port numbers (e.g., ports in the range 1025-65536). For example, the allowed list of port numbers may exclude known used ports (e.g., port 80 for HTTP), system reserved ports (e.g., ports 1-1024 may be reserved by the system such that only a process with root access is permitted to use them), or both. In some example embodiments, the allowed list of port numbers is controlled by an administrator. For example, one application being tested may be assigned ports in the range 2000-2999 and another application being tested may be assigned ports in the range 3000-3999.

If the request is granted (operation 720), the method 700 continues with operation 730. Otherwise, the method proceeds to operation 760. In operation 760, the test script changes the port number (e.g., by incrementing it from 1999 to 2000) and repeats operation 710. Operations 710, 720, and 760 are repeated until a request is granted.

The test script reserves a TCP port with the port number for an instance of an application (operation 730). The test script may provide the reserved port number to an instance of a second application that connects to the instance of the application using the TCP port. For example, the application may be a server application that receives requests using the TCP port and the second application may be a client application that makes requests using the TCP port.

In operation 740, the test script executes the instance of the application, using the reserved TCP port. In some example embodiments, the test script starts the instance of the application using a command line that indicates the port number. After the instance of the application completes execution, in operation 750, the test script releases the UDP port that was successfully requested in operation 710.

The method 700 may be performed simultaneously by multiple test scripts running on a server. Whether the test scripts are run in the same file module specific namespace or different file module specific namespaces, the method 700 ensures that every instance of the application will use a different TCP port.

For example, a first test script may request a first UDP port with a first port number (operation 710) and, based on being granted the first UDP port (operation 720), reserve a first TCP port with the first port number for a first instance of an application (operation 730). A second test script may request a second UDP port with a second port number (operation 710). In this example, the second port number is either the same as the first port number or is another port number that is already in use. Based on being denied the second UDP port (operation 720), the second test script requests a third UDP port with a third UDP port number (operation 710, after operation 760). Based on being granted the third UDP port (operation 720), the second test script reserves a second TCP port with the third port number for a second instance of the application (operation 730). Thus, when the two instances are executed using their respective reserved TCP ports (operation 740, once for each of the two test scripts), both instances are able to successfully execute without attempting to use the same TCP port. Furthermore, this is true even when the two instances of the application execute in different file module specific namespaces.

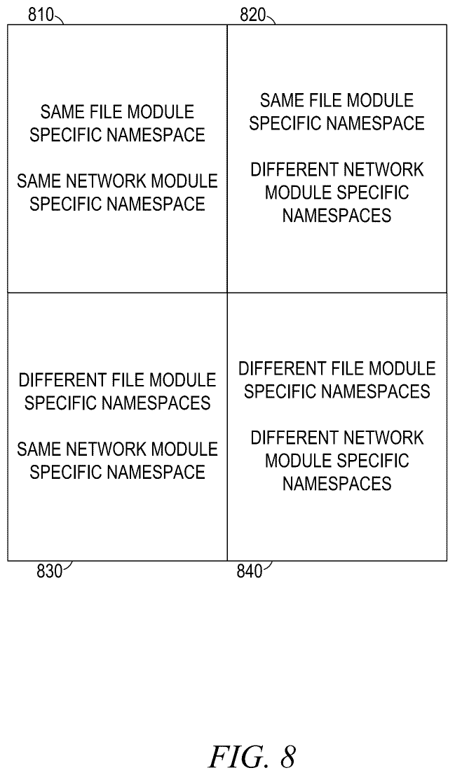

FIG. 8 illustrates four combinations 810, 820, 830, and 840 of operating system namespaces for two test scripts. In combinations 810 and 820, the two test scripts execute in the same file module specific namespace. Accordingly, the file-based TCP port reservation system of FIG. 3 can be used. In combinations 820 and 830, the two test scripts execute in different network module specific namespaces. Accordingly, even if the two test scripts attempt to use the same TCP port, there is no conflict. However, in combination 830, the two test scripts execute in different file module specific namespaces. As a result, as discussed with respect to FIG. 4, a file-based TCP port reservation system will not be effective.

By contrast, the TCP port reservation system discussed with respect to FIGS. 5-7 is consistent with operating system namespaces. The UDP ports used for reservation purposes are shared in the same was as the TCP ports being reserved. As a result, in combinations 810 and 830, where the two scripts are running in the name network module specific namespace, the UDP-based reservation system can be used effectively. In combinations 820 and 840, where the two scripts are running in different network module specific namespaces, using the same TCP port does not cause a conflict.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: one or more hardware processors; and a memory that stores instructions that, when executed by the one or more processors, cause the one or more processors to perform operations comprising: requesting a User Datagram Protocol (UDP) port with a port number; and based on being granted the UDP port, reserving a Transmission Control Protocol (TCP) port with the port number for an instance of an application.

In Example 2, the subject matter of Example 1, wherein the operations further comprise: requesting a second UDP port with a second port number; based on being denied the second UDP port, requesting a third UDP port with a third port number; and based on being granted the third UDP port, reserving a second TCP port with the third port number for a second instance of the application.

In Example 3, the subject matter of Examples 1-2, wherein the operations further comprise: starting the instance of the application using a command line that indicates the port number.

In Example 4, the subject matter of Example 3, wherein the operations further comprise: based on a determination that the instance of the application has terminated, releasing the UDP port.

In Example 5, the subject matter of Examples 3-4, wherein the operations further comprise: requesting a second UDP port with a second port number; based on being granted the second UDP port, reserving a TCP port with the second port number for a second instance of the application; starting the second instance of the application using a second command line that indicates the second port number.

In Example 6, the subject matter of Example 5, wherein the instance of the application and the second instance of the application execute in different file module specific namespaces.

In Example 7, the subject matter of Examples 5-6, wherein the instance of the application and the second instance of the application execute in a same file module specific namespaces.

In Example 8, the subject matter of Examples 5-7, wherein the instance of the application and the second instance of the application execute in different network module specific namespaces.

In Example 9, the subject matter of Examples 5-8, wherein the instance of the application and the second instance of the application execute in a same network module specific namespaces.

In Example 10, the subject matter of Examples 3-9, wherein the operations further comprise: providing the port number to an instance of a second application that connects to the instance of the application using the TCP port.

In Example 11, the subject matter of Examples 1-10, wherein the operations further comprise: selecting the port number from an allowed list of port numbers.

Example 12 is a non-transitory computer-readable medium that stores instructions that, when executed by one or more processors, cause the one or more processors to perform operations comprising: requesting a User Datagram Protocol (UDP) port with a port number; and based on being granted the UDP port, reserving a Transmission Control Protocol (TCP) port with the port number for an instance of an application.

In Example 13, the subject matter of Example 12, wherein the operations further comprise: requesting a second UDP port with a second port number; based on being denied the second UDP port, requesting a third UDP port with a third port number; and based on being granted the third UDP port, reserving a second TCP port with the third port number for a second instance of the application.

In Example 14, the subject matter of Examples 12-13, wherein the operations further comprise: starting the instance of the application using a command line that indicates the port number.

In Example 15, the subject matter of Example 14, wherein the operations further comprise: based on a determination that the instance of the application has terminated, releasing the UDP port.

In Example 16, the subject matter of Examples 14-15, wherein the operations further comprise: requesting a second UDP port with a second port number; based on being granted the second UDP port, reserving a TCP port with the second port number for a second instance of the application; starting the second instance of the application using a second command line that indicates the second port number.

Example 17 is a method comprising: requesting, by one or more processors, a User Datagram Protocol (UDP) port with a port number; and based on being granted the UDP port, reserving a Transmission Control Protocol (TCP) port with the port number for an instance of an application.

In Example 18, the subject matter of Example 17 includes requesting a second UDP port with a second port number; based on being denied the second UDP port, requesting a third UDP port with a third port number; and based on being granted the third UDP port, reserving a second TCP port with the third port number for a second instance of the application.

In Example 19, the subject matter of Examples 17-18 includes starting the instance of the application using a command line that indicates the port number.

In Example 20, the subject matter of Example 19 includes, based on a determination that the instance of the application has terminated, releasing the UDP port.

Example 21 is an apparatus comprising means to implement any of Examples 1-20.

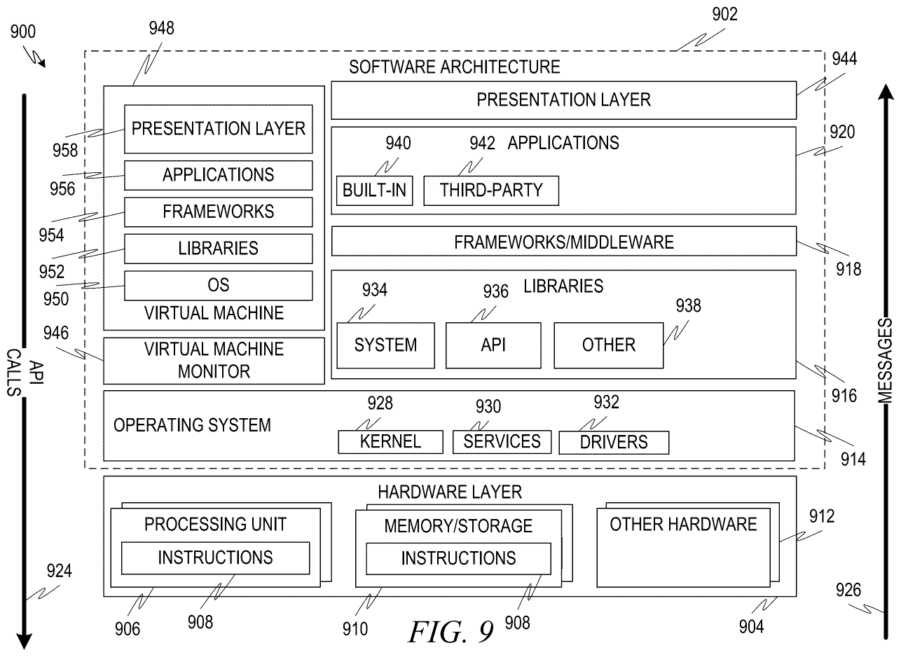

FIG. 9 shows a block diagram 900 showing one example of a software architecture 902 for a computing device. The software architecture 902 may be used in conjunction with various hardware architectures, for example, as described herein. FIG. 9 is merely a non-limiting example of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 10 shows a block diagram of a machine in the example form of a computer system 1000 within which instructions 1024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube [CRT]). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting a machine-readable medium 1022.

While the machine-readable medium 1022 is shown in FIG. 10 to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with the instructions 1024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
one or more hardware processors; and
a memory that stores instructions that, when executed by the one or more processors, cause the one or more processors to perform operations comprising:
requesting a User Datagram Protocol (UDP) port with a port number; and
based on being granted the UDP port, reserving a Transmission Control Protocol (TCP) port with the port number for an instance of an application.

2. The system of claim 1, wherein the operations further comprise:
requesting a second UDP port with a second port number;
based on being denied the second UDP port, requesting a third UDP port with a third port number; and
based on being granted the third UDP port, reserving a second TCP port with the third port number for a second instance of the application.

3. The system of claim 1, wherein the operations further comprise:
starting the instance of the application using a command line that indicates the port number.

4. The system of claim 3, wherein the operations further comprise:
based on a determination that the instance of the application has terminated, releasing the UDP port.

5. The system of claim 3, wherein the operations further comprise:
requesting a second UDP port with a second port number;
based on being granted the second UDP port, reserving a TCP port with the second port number for a second instance of the application;
starting the second instance of the application using a second command line that indicates the second port number.

6. The system of claim 5, wherein the instance of the application and the second instance of the application execute in different file module specific namespaces.

7. The system of claim 5, wherein the instance of the application and the second instance of the application execute in a same file module specific namespaces.

8. The system of claim 5, wherein the instance of the application and the second instance of the application execute in different network module specific namespaces.

9. The system of claim 5, wherein the instance of the application and the second instance of the application execute in a same network module specific namespaces.

10. The system of claim 3, wherein the operations further comprise:
providing the port number to an instance of a second application that connects to the instance of the application using the TCP port.

11. The system of claim 1, wherein the operations further comprise:
selecting the port number from an allowed list of port numbers.

12. A non-transitory computer-readable medium that stores instructions that, when executed by one or more processors, cause the one or more processors to perform operations comprising:
requesting a User Datagram Protocol (UDP) port with a port number; and
based on being granted the UDP port, reserving a Transmission Control Protocol (TCP) port with the port number for an instance of an application.

13. The non-transitory computer-readable medium of claim 12, wherein the operations further comprise:
requesting a second UDP port with a second port number;
based on being denied the second UDP port, requesting a third UDP port with a third port number; and
based on being granted the third UDP port, reserving a second TCP port with the third port number for a second instance of the application.

14. The non-transitory computer-readable medium of claim 12, wherein the operations further comprise:
starting the instance of the application using a command line that indicates the port number.

15. The non-transitory computer-readable medium of claim 14, wherein the operations further comprise:
based on a determination that the instance of the application has terminated, releasing the UDP port.

16. The non-transitory computer-readable medium of claim 14, wherein the operations further comprise:
requesting a second UDP port with a second port number;
based on being granted the second UDP port, reserving a TCP port with the second port number for a second instance of the application;
starting the second instance of the application using a second command line that indicates the second port number.

17. A method comprising:
requesting, by one or more processors, a User Datagram Protocol (UDP) port with a port number; and
based on being granted the UDP port, reserving a Transmission Control Protocol (TCP) port with the port number for an instance of an application.

18. The method of claim 17, further comprising:
requesting a second UDP port with a second port number;
based on being denied the second UDP port, requesting a third UDP port with a third port number; and
based on being granted the third UDP port, reserving a second TCP port with the third port number for a second instance of the application.

19. The method of claim 17, further comprising:
starting the instance of the application using a command line that indicates the port number.

20. The method of claim 19, further comprising:
based on a determination that the instance of the application has terminated, releasing the UDP port.
